(19) United States
(12) Patent Application Publication
(10) Pub. No.: US 2013/0325230 A1
(43) Pub. Date: Dec. 5, 2013

(54) APPARATUS AND METHOD OF CONTROLLING MOTOR TORQUE FOR ENVIRONMENT FRIENDLY VEHICLE

(71) Applicants: HYUNDAI MOTOR COMPANY, Seoul (KR); KIA MOTORS CORPORATION, Seoul (KR)

(72) Inventor: Sang Joon Kim, Seoul (KR)

(73) Assignees: KIA MOTORS CORPORATION, Seoul (KR); HYUNDAI MOTOR COMPANY, Seoul (KR)

(21) Appl. No.: 13/727,049

(22) Filed: Dec. 26, 2012

(30) Foreign Application Priority Data
Jun. 5, 2012 (KR) 10-2012-0060459

(51) Int. Cl. B60W 30/18; B60W 20/00; B60W 10/18; B60W 10/08

(52) U.S. Cl. CPC B60W 30/18072; B60W 10/08; B60W 20/108; B60W 10/18; Y10S 903/93; Y10S 903/947
USPC 701/22; 903/930; 903/947

(57) ABSTRACT

Disclosed is a method of controlling motor torque of a vehicle capable of increasing vehicle mileage and improving fuel efficiency by adjusting regenerative torque of a motor according to a driving tendency of a driver when a vehicle is in a coasting mode by detecting a driving tendency of a driver by analyzing the number of brake pedal operations and engaging depth of a brake pedal for a predetermined period

### CROSS-REFERENCE TO RELATED APPLICATION

This application claims priority to and the benefit of Korean Patent Application No. 10-2012-0060459 filed in the Korean Intellectual Property Office on Jun. 5, 2012, the entire contents of which are incorporated herein by reference.

### BACKGROUND OF THE INVENTION

(a) Field of the Invention

The present invention relates to a motor torque control apparatus for an environment friendly vehicle, and more particularly, to an apparatus and a method of controlling motor torque for an environment friendly vehicle capable of increasing vehicle mileage and improving fuel efficiency by adjusting regenerative torque of a motor according to a tendency of a driver when a vehicle is coasting.

(b) Description of the Related Art

According to demands for improvement of fuel efficiency for a vehicle and exhaust gas regulations, a demand for an environment friendly vehicle has increased. The environment friendly vehicle includes a fuel cell vehicle, an electric vehicle, a plug-in electric vehicle, a hybrid vehicle, and the like, and includes one or more motors and engines, and a battery in which high voltage power for driving the motor is stored, an inverter for converting a DC voltage of the battery to an AC voltage, a hybrid starter generator (HSG) for starting the engine and generating power, and an engine clutch mounted between the engine and the motor for transmitting power of the engine to a driving side.

The hybrid vehicle may improve energy efficiency and decrease exhaust gas by operating characteristics of an engine and a motor according to a driving condition thereof. The hybrid vehicle provides an electric vehicle (EV) mode (electric mode) for driving through an operation of only the motor according to an acceleration/deceleration intention and load transmitted through an operation of an acceleration pedal and a brake pedal and a state of charge (SOC) of a battery, and a hybrid electric vehicle (HEV) mode (hybrid mode) for driving within the region in which efficiency of the engine and the motor is optimized by combining the motor and the engine through an engine clutch.

When a coasting mode is executed (e.g., driving on a highway) due to generation of disengagement of a brake pedal when the hybrid vehicle drives in the EV mode or the HEV mode through engagement of the acceleration pedal, regenerative torque is generated to collect energy, so regenerative charging for charging the battery is implemented.

However, when the coasting mode is implemented, a size of the regenerative torque and vehicle mileage have a correlation, and when the battery charging is increased by increasing the regenerative torque, vehicle mileage decreases. Accordingly, it is necessary to adjust the regenerative torque in an appropriate level to improve fuel efficiency. However, due to various driving conditions, especially, driving tendencies of drivers, the correlation between the regenerative torque and the mileage cannot be accurately determined according to the various driving conditions.

Particularly, when driving torque and regenerative torque are continuously converted based on a particular driving style (i.e. driving tendency), unnecessary recirculation of energy ma y be frequently generated and vehicle mileage may be reduced, thereby causing fuel efficiency to deteriorate.

The above information disclosed in this section is only for enhancement of understanding of the background of the invention and therefore it may contain information that does not form the prior art that is already known in this country to a person of ordinary skill in the art.

### SUMMARY OF THE INVENTION

The present invention provides an apparatus and a method of controlling motor torque for an environment friendly vehicle having advantages of stably charging a battery, increasing vehicle mileage, and improving fuel efficiency by learning a tendency of a driver and variably adjusting regenerative torque of the motor according to the tendency of the driver when the vehicle is in a coasting mode.

An exemplary embodiment of the present invention provides an apparatus for controlling motor torque for an environment friendly vehicle capable of performing regenerative braking, the apparatus including: a brake pedal detection unit configured to detect when a brake pedal is engaged and an engaging depth (e.g. the amount a brake pedal is decompressed) of the brake pedal; a hybrid control unit configured to determine a driving tendency of a driver by analyzing the number of brake pedal operations and the engaging depth of the brake pedal, and adjust regenerative torque of a motor according to the driving tendency of the driver when the brake pedal is engaged while the driving in an EV (electric vehicle) mode or an HEV (hybrid electric vehicle) mode; and an inverter configured to adjust the regenerative torque of the motor according to control of the hybrid control unit.

The hybrid control unit may extract the average number of times of operation by summing the number of brake pedal operations during a predetermined driving cycle and calculating an average of the engaging depth of the brake pedal to determine the driving tendency of the driver according to the average number of brake pedal operations and the average of the engaging depth of the brake pedal.

When the number of brake pedal operations exceeds a range of the predetermined reference number and the average engaging depth of the brake pedal exceeds a predetermined reference depth range, the hybrid control unit may determine that the driving tendency of the driver is an aggressive tendency. When determined that the driving tendency of the driver detected according to the brake pedal operation is an aggressive tendency, the hybrid control unit may increase the regenerative torque of the motor to increase the amount of regenerative braking.

When the number of brake pedal operations is less than a range of the predetermined reference number and the average engaging depth of the brake pedal is less than a predetermined reference depth range, the hybrid control unit may determine that the driving tendency of the driver is a mild tendency. When the driving tendency of the driver is determined as the mild tendency, the hybrid control unit may decrease the regenerative torque of the motor.

When the number of brake pedal operations is within a range of the predetermined reference number and the average engaging depth of the brake pedal is within a predetermined reference depth range, the hybrid control unit may determine that the driving tendency of the driver is a typical tendency. When the driving tendency of the driver is the typical tendency, the hybrid control unit may control the regenerative torque of the motor to be a predetermined basic value.

The apparatus may further include an acceleration pedal detection unit configured to detect engagement and disengagement of an acceleration pedal and a position of the acceleration pedal, wherein the hybrid control unit may determine the driving tendency of the driver by further including the number of operations and an operation engaging depth of the acceleration pedal during a predetermined driving cycle.

Another exemplary embodiment of the present invention provides a method of controlling motor torque of an environment friendly vehicle capable of performing regenerative braking, the method including: detecting, by a sensor, a driving tendency of a driver by analyzing, by a controller, the number of brake pedal operations and engaging depth of a brake pedal for a predetermined period; and when disengagement of the brake pedal is detected in an EV mode or an HEV mode, adjusting regenerative torque of a motor according to the detected driving tendency of the driver.

In detecting the driving tendency of the driver, the average number of operations may be calculated by a controller, summing the number of brake pedal operations for the predetermined period and an average engaging depth of the brake pedal may be calculated to determine the driving tendency of the driver according to the average number of operations and the average of the engaging depth of the brake pedal.

When the number of brake pedal operations exceeds a range of the reference number and the average engaging depth exceeds a predetermined reference range, the driving tendency of the driver may be determined as an aggressive tendency, and regenerative torque of the motor may be increased.

When the number of brake pedal operations is less than a range of the reference number and the average engaging depth is less than a predetermined reference range, the driving tendency of the driver may be determined as a mild tendency, and regenerative torque of the motor may be decreased.

When the number of brake pedal operations is within a range of the reference number and the average of the engaging depth is within a predetermined reference range, the driving tendency of the driver may be determined as a typical tendency, and the regenerative torque of the motor may be controlled to be a predetermined basic value.

As described above, the environment friendly vehicle according to the present invention variably controls the regenerative torque according to the driving tendency of the driver during a coasting mode according to the disengagement, thereby increasing vehicle mileage and improving fuel efficiency.

When the driving tendency of the driver is mild tendency during a coasting mode according to the disengagement, the regenerative torque is decreased to prevent energy from being frequently recirculated, thereby improving fuel efficiency.

Further, when the driving tendency of the driver is aggressive tendency during the coasting mode according to the disengagement, the regenerative torque is increased to induce driving in which the number of frequent operations of the brake pedal for deceleration and sharp deceleration is decreased.

### BRIEF DESCRIPTION OF THE DRAWINGS

FIG. 1 is an exemplary diagram illustrating a motor torque control apparatus for an environment friendly vehicle according to an exemplary embodiment of the present invention.

FIG. 2 is an exemplary flowchart illustrating a procedure of motor torque control for an environment friendly vehicle according to an exemplary embodiment of the present invention.

FIG. 3 is an exemplary flowchart illustrating a procedure of detecting a driving tendency of a driver for motor torque control in an environment friendly vehicle according to an exemplary embodiment of the present invention.

Description of symbols

| | |
|---|---|
| 101: APS | 102: BPS |
| 103: Hybrid control unit | 104: Inverter |
| 105: Battery | 106: Battery management unit |
| 107: Engine control unit | 108: Motor |

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules/units and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification. Further, each configuration illustrated in the drawings are arbitrarily shown for understanding and ease of description, but the present invention is not limited thereto.

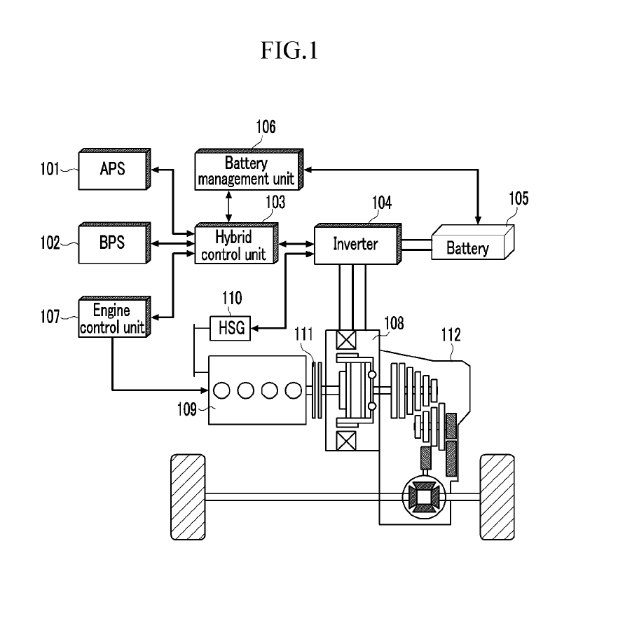

FIG. 1 is an exemplary diagram illustrating a motor torque control apparatus for an environment friendly vehicle according to an exemplary embodiment of the present invention.

Referring to FIG. 1, the motor torque control apparatus for the environment friendly vehicle according to the exemplary embodiment of the present invention may include an acceleration pedal position sensor (APS) 101, a brake position sensor (BPS) 102, a hybrid control unit 103, an inverter 104, a battery 105, a battery management unit 106, an engine control unit 107, a motor 108, an engine 109, a hybrid starter and generator (HSG) 110, an engine clutch 111, and a transmission 112.

The APS 101 may detect engagement or disengagement of an acceleration pedal and a position of the acceleration pedal and may send the hybrid control unit 103 an electric signal with information on the acceleration pedal. The BPS 102 may detect when a brake pedal is engaged and an engaging depth, a depth by which the brake pedal is engaged (e.g., a position of the brake pedal), and may send the hybrid control unit 103 an electric signal with information on the brake pedal.

The hybrid control unit 103 (i.e., a type of controller) may detect a driving habit of a driver by analyzing the number of brake pedal operations and the engaging depth detected by the BPS 102 during a predetermined driving cycle (e.g., N driving cycle) when the vehicle travels in the EV (electric vehicle) mode or the HEV (hybrid electric vehicle) mode, and may classify the driving tendency of the driver into a mild tendency, a typical tendency, and an aggressive tendency based on the driving habit to determine the driving tendency of the driver. For example, in a mild driving tendency, a driver engages the brake pedal less than in an aggressive driving tendency.

The hybrid control unit 103 may calculate the average number of brake pedal operations by summing the number of brake pedal operations detected by the BPS 102 during the predetermined driving cycle when the vehicle travels in the EV mode or the HEV mode, may calculate an average of the engaging depth, and may determine the driving tendency of the driver according to the average number of brake pedal operations and the average engaging depth.

For example, when the number of brake pedal operations exceeds the predetermined reference number and the average engaging depth exceeds a predetermined reference depth, the hybrid control unit 103 may detect an aggressive tendency. The driving cycle (e.g., N driving cycle) may be randomly set in advance according to a vehicle with the appropriate number of times through which the driving tendency of the driver may be determined.

Further, when the number of brake pedal operations is less than the predetermined reference number and the average engaging depth does not exceed a predetermined reference depth range, the hybrid control unit 103 may detect a mild tendency (e.g., typical driving condition). In addition, when the number of brake pedal operations is within the range of the predetermined reference number and the average engaging depth is within the reference depth range, the hybrid control unit 103 may detect a typical tendency.

In the exemplary embodiment of the present invention, the reference depth range of the brake pedal and the range of the reference number of brake pedal operations set for detecting the driving tendency of the driver may be set according to a type of vehicle. Further, in the exemplary embodiment of the present invention, the driving tendency of the driver may be classified into three driving habits, such as the mild driving habit, the typical driving habit, and the aggressive driving habit, according to the reference depth range of the brake pedal and the range of the reference number of brake pedal operations, but the present invention is not limited thereto, and the driving tendency of the driver may be classified into two or four or more driving tendencies to control the motor torque according to the classified driving tendency.

The hybrid control unit 103 may determine the driving tendency of the driver by analyzing only the information on the number of brake pedal operations and the engaging depth of the brake pedal, and may more accurately determine the driving tendency of the driver when the number of pedal operations of the acceleration pedal and displacement are applied together, so the hybrid control unit 103 may further include information provided from the APS 101 for determining the driving tendency of the driver.

When the information provided from the APS 101 is disengagement and the information provided from the BPS 102 is detected as the operation of the brake pedal when the tendency of the driver has been determined, the hybrid control unit 103 may determine the detected tendency of the driver and may variably control regenerative torque of the motor 108 through the inverter 104.

When the hybrid control unit 103 determines that the detected tendency of the driver is the aggressive driving tendency, the hybrid control unit 103 may increase the amount of generation of regenerative brake power by controlling the inverter 104 to increase regenerative torque of the motor, thereby increasing a deceleration effect. Accordingly, charging efficiency of the battery 105 may be increased and a frequency of the brake pedal operation may decrease, thereby reducing energy recirculation generation.

When the hybrid control unit 103 determines that the detected tendency of the driver is the mild driving tendency, the hybrid control unit 103 may increase vehicle mileage by controlling the inverter 104 to decrease regenerative torque of the motor 108. Accordingly, fuel efficiency may be improved.

When the hybrid control unit 103 determines that the detected tendency of the driver is the typical driving tendency, the hybrid control unit 103 may control the inverter 104 to maintain the regenerative torque of the motor 108 at a basic value.

During a coasting mode, the inverter 104 may control the regenerative torque of the motor 108 according to a control signal provided from the hybrid control unit 103 through a network. The inverter 104 may include a plurality of power switching elements, and each power switching element may include any one of an insulated gate bipolar transistor (IGBT), a metal-oxide-semiconductor field-effect transistor (MOSFET), and a transistor. The battery 105 may include a plurality of unit cells, and may store a high voltage, such as, a DC voltage of 350 V to 450 V, to supply a driving voltage to the motor 108.

The battery management unit 106 may manage a state of charge (SOC) of the battery by detecting a current, a voltage, a temperature, and the like of each of the unit cells within an operation region of the battery 105, and may control a charge/discharge voltage of the battery 105 to prevent the battery 106 from being over discharged to a limited voltage or lower or over charged to a limited voltage or higher and prevent lifespan from decreasing.

The engine control unit 107 may control the operation of the engine 109 according to a control signal sent from the hybrid control unit 103 through the network.

The motor 108 may be operated by a three-phase AC voltage applied from the inverter 104 to generate driving torque, and may be operated as a generator during the coasting mode to supply regenerative energy to the battery 105. Starting on/off and output of the engine 109 may be controlled by the control of the engine control unit 107.

The HSG 110 may be operated as a starter and a generator, may execute a starting of the engine 109 according to the control signal sent from the hybrid control unit 103, may be operated as the generator when the engine 109 is maintained in a starting-on state, to generate electric energy, and may supply the generated electric energy to the battery 105 through the inverter 104.

The engine clutch 111 may be disposed between the engine 109 and the motor 108 to connect or cut off power between the engine 109 and the motor 108 according to a switch between the EV mode and the HEV mode.

The transmission 112 may be connected with the hybrid control unit 103 through the network to perform change of speed with a target transmission stage.

A procedure of the motor torque control for the environment friendly vehicle including the aforementioned functions according to the present invention will be described below.

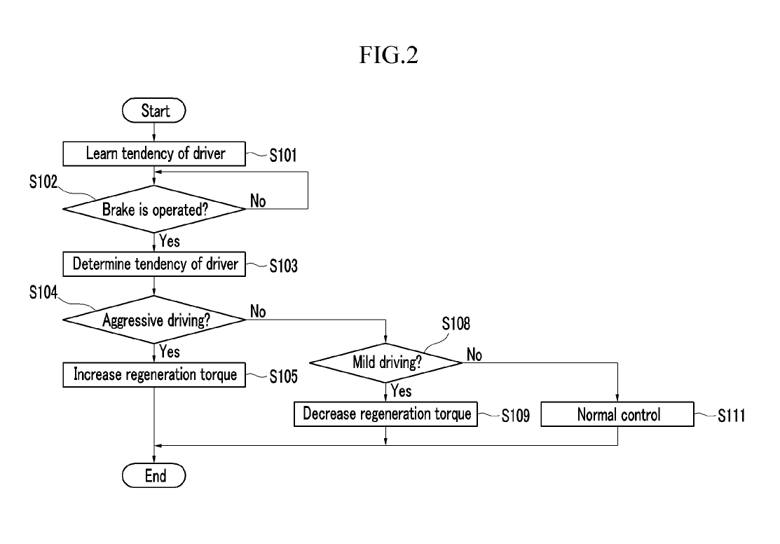

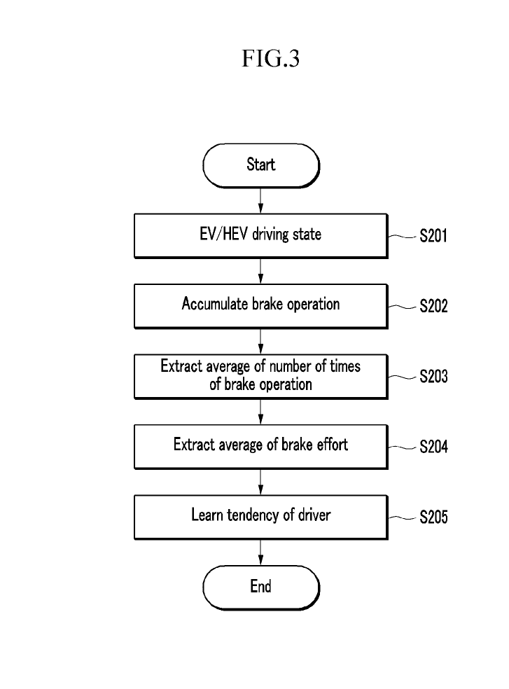

FIG. 2 is an exemplary flowchart illustrating the procedure of the motor torque control for the environment friendly vehicle according to the exemplary embodiment of the present invention, and FIG. 3 is an exemplary flowchart illustrating a procedure of detecting a driving tendency of a driver for the motor torque control in the environment friendly vehicle according to the exemplary embodiment of the present invention.

Referring to FIG. 2, when the environment friendly vehicle is driven in the EV mode or the HEV mode, the hybrid control unit 103 may detect a driving habit by analyzing the number of brake pedal operations and an engaging depth, which are determined by the BPS 102 for a predetermined driving cycle, and may detect a tendency of the driver based on the driving habit (S 101).

The hybrid control unit 103 may detect the driving habit of the driver by analyzing the number of brake pedal operations and the engaging depth, and may classify the driving tendency of the driver into a mild tendency, a typical tendency, an aggressive tendency, and the like based on the driving habit. The detecting of the driving tendency of the driver will be described in more detail with reference to FIG. 3 below.

When the environment friendly vehicle is driven in the EV mode or the HEV mode (S201), the hybrid control unit 103 may add the number of brake pedal operations detected from the BPS 102 during the predetermined driving cycle (S202), calculate the average number for the added number of brake pedal operations (S203), and calculate an average of the engaging depth (S204).

In addition, the hybrid control unit 103 may determine the driving tendency of the driver by analyzing the driving habit of the driver according to the average number of brake pedal operations calculated in step S203 and the average engaging depth calculated in step S204 (S205). For example, when the number of brake pedal operations exceeds a range of the predetermined reference number and the average engaging depth exceeds a predetermined reference depth range, the hybrid control unit 103 may determine the aggressive tendency.

Further, when the number of brake pedal operations is less than the range of the predetermined reference number and the average engaging depth does not exceed the predetermined reference depth range, the hybrid control unit 103 may determine the mild tendency (e.g., typical driving operation). Moreover, when the number of brake pedal operations is within the range of the predetermined reference number and the average engaging depth is within the reference depth range, the hybrid control unit 103 may determine the typical tendency.

The method of the hybrid control unit 103 determining the driving tendency of the driver by analyzing only the information on the number of brake pedal operations and the engaging depth of the brake pedal has been described as an example. However, when the number of pedal operations times of the acceleration pedal and displacement are applied together, the hybrid control unit 103 may more accurately determine the driving tendency of the driver, so the hybrid control unit 103 may further include information provided from the APS 101 for detecting the driving tendency of the driver.

Referring to FIG. 2, when the hybrid control unit 103 detects the tendency of the driver through the aforementioned procedure, the hybrid control unit 103 may determine whether the information provided from the APS 101 is disengagement of the brake pedal and whether the brake pedal is operated through the information provided from the BPS 102 (S102). When the information provided from the APS 101 is disengagement and the information provided from the BPS 102 is detected as the operation of the brake pedal in step S102, the hybrid control unit 103 may determine the detected tendency of the driver (S 103) and may determine whether the driver has the aggressive tendency (S104).

When the aggressive tendency is determined in step S104, the hybrid control unit 103 may increase the amount of generation of regenerative brake power by controlling the inverter 104 to increase the regenerative torque of the motor 108 (S105). Accordingly, a deceleration effect of the vehicle may be improved.

In other words, when the driving tendency of the driver is the aggressive tendency, charging efficiency of the battery 105 may be improved by increasing the regenerative torque and frequent generation of energy recirculation may be prevented by decreasing a frequency of brake pedal operation.

When the mild tendency is determined (S108), the hybrid control unit 103 may control the inverter 104 to decrease the regenerative torque of the motor 108 (S109). Accordingly, vehicle mileage of the vehicle may be increased and fuel efficiency may be improved.

Further, when the typical driving tendency is determined typical (S111), the hybrid control unit 103 control the inverter 104 to maintain the regenerative torque of the motor 108 at a basic value.

Further, in the exemplary embodiment of the present invention, the driving tendency of the driver may be classified into three driving tendencies, such as the mild driving tendency, the typical driving tendency, and the aggressive driving tendency, according to the reference depth range of the brake pedal and the range of the reference number of brake pedal operations, but the present invention is not limited thereto, and the driving tendency of the driver may be classified into two or four or more driving tendencies to control the motor torque according to the classified driving tendency.

The aforementioned description has been made based on the hybrid vehicle, but the present invention is not limited thereto, and the apparatus and the method of controlling motor torque for the vehicle according to the exemplary embodiment of the present invention may be applied to all types of vehicles capable of performing regenerative braking when the brake pedal is operated.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

What is claimed is:

1. An apparatus for controlling motor torque of a vehicle capable of performing regenerative braking, the apparatus comprising:
a brake pedal sensor configured to detect when a brake pedal is operated and an engaging depth of the brake pedal;
a hybrid control unit configured to:
determine a driving tendency of a driver by analyzing the number of brake pedal operations and the engaging depth of the brake pedal; and
control an inverter to adjust regenerative torque of a motor according to the driving tendency of the driver when the brake pedal operation is detected during the driving in an EV (electric vehicle) mode or an HEV (hybrid electric vehicle) mode

2. The apparatus of claim 1, wherein the hybrid control unit is further configured to:
calculate an average number of brake pedal operations by summing the number of brake pedal operations during a predetermined driving cycle; and
calculate an average of the engaging depth of the brake pedal to determine the driving tendency of the driver according to the average number of brake pedal operations and the average engaging depth of the brake pedal.

3. The apparatus of claim 2, wherein the hybrid control unit is further configured to:
determine an aggressive driving tendency when the number of brake pedal operations exceeds a range of a predetermined reference number and the average engaging depth of the brake pedal exceeds a predetermined reference depth range.

4. The apparatus of claim 3, wherein the hybrid control unit is further configured to:
control the inverter to increase the regenerative torque of the motor to increase the amount of regenerative braking in response to determining the aggressive driving tendency.

5. The apparatus of claim 2, wherein the hybrid control unit is further configured to:
determine a mild driving tendency when the number of brake pedal operations is less than a range of the predetermined reference number and the average engaging depth of the brake pedal is less than a predetermined reference depth range.

6. The apparatus of claim 5, wherein the hybrid control unit is further configured to:
control the inverter to decrease the regenerative torque of the motor in response to determining the mild driving tendency.

7. The apparatus of claim 2, wherein the hybrid control unit is further configured to:
determine a typical driving tendency when the number of brake pedal operations is within a range of the predetermined reference number and the average engaging depth of the brake pedal is within a predetermined reference depth range typical.

8. The apparatus of claim 7, wherein the hybrid control unit is further configured to:
control the inverter to maintain the regenerative torque as a predetermined basic value in response to determining the typical driving tendency. typical

9. The apparatus of claim 2, wherein the apparatus further comprises:
an acceleration pedal sensor configured to detect engagement and disengagement of an acceleration pedal and a position of the acceleration pedal, wherein the hybrid control unit is configured to determine the driving tendency of the driver by including the number of pedal operations and an engaging depth of the acceleration pedal during a predetermined driving cycle.

10. A method of controlling motor torque of a vehicle capable of performing regenerative braking, the method comprising:
determining, by a brake pedal sensor, when a brake pedal is operated and an engaging depth of the brake pedal;
determining, by a controller, a driving tendency of a driver by analyzing the number of brake pedal operations and the engaging depth of a brake pedal for a predetermined period; and
controlling, by the controller, an inverter to adjust regenerative torque of a motor according to the determining driving tendency when disengagement and the brake pedal operation are detected in an EV mode or an HEV mode.

11. The method of claim 10, further comprising:
calculating, by the controller, an average number of brake pedal operations by summing the number of brake pedal operations over the predetermined period; and
calculating, by the controller, an average of the engaging depth of the brake pedal to determine the driving tendency of the driver.

12. The method of claim 10, further comprising:
determining, by the controller, an aggressive driving tendency; and
controlling, by the controller, the inverter to increase the regenerative torque when the number of brake pedal operations exceeds a range of the reference number and the average engaging depth exceeds a predetermined reference range.

13. The method of claim 10, further comprising:
determining, by the controller, a mild driving tendency; and
controlling, by the controller, the inverter to decrease the regenerative torque when the number of brake pedal operations is less than a range of the reference number and the average engaging depth is less than a predetermined reference range.

14. The method of claim 10, further comprising:
determining, by the controller, a typical driving tendency;
controlling, by the controller, the inverter to maintain the regenerative torque as a predetermined basic value when the number of brake pedal operations is within a range of the reference number of times and the average of the engaging depth of the brake pedal is within a predetermined reference range typical.

15. A non-transitory computer readable medium containing program instructions executed by a or controller, the computer readable medium comprising:
program instructions that determines a driving tendency of a driver by analyzing a number of brake pedal operations and an engaging depth of a brake pedal for a predetermined period; and
program instructions that control an inverter to adjust regenerative torque of a motor according to the determined driving tendency when disengagement and brake pedal operation are detected in an EV mode or an HEV mode.

16. The computer readable medium of claim 15, further comprising:
program instructions that calculate an average number of brake pedal operations by summing the number of brake pedal operations over the predetermined period; and
program instructions that calculate an average of the engaging depth of the brake pedal to determine the driving tendency of the driver.

17. The computer readable medium of claim 15, further comprising:
program instructions that determine an aggressive driving tendency; and
program instructions that control the inverter to increase the regenerative torque when the number of brake pedal operations exceeds a range of the reference number and the average engaging depth exceeds a predetermined reference range.

18. The computer readable medium of claim 15, further comprising:
program instructions that determine an aggressive driving tendency; and
program instructions that control the inverter to increase the regenerative torque when the number of brake pedal operations exceeds a range of the reference number and the average engaging depth exceeds a predetermined reference range.

19. The computer readable medium of claim 15, further comprising:
program instructions that determine a mild driving tendency; and
program instructions that control the inverter to decrease the regenerative torque when the number of brake pedal operations is less than a range of the reference number and the average engaging depth is less than a predetermined reference range.

20. The computer readable medium of claim 15, further comprising:
program instructions that determine a typical driving tendency;
program instructions that control the inverter to maintain the regenerative torque as a predetermined basic value when the number of brake pedal operations is within a range of the reference number of times and the average of the engaging depth of the brake pedal is within a predetermined reference range.
